(19) United States
(12) Patent Application Publication
(10) Pub. No.: US 2005/0126406 A1
(43) Pub. Date: Jun. 16, 2005

(54) Die plate for a foil stamping machine

(76) Inventors: Alan J. Fawcett, Arcadia (AU); Glen L. Wright, Arcadia (AU)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 10/500,947

(22) PCT Filed: Jan. 7, 2003
(86) PCT No.: PCT/AU03/00012

(30) Foreign Application Priority Data
Jan. 7, 2002 (AU) PR 9859
Apr. 19, 2002 (AU) PS 1847

(51) Int. Cl. B44B 5/02; B41F 27/00

(52) U.S. Cl. 101/28; 101/382.1

(57) ABSTRACT

A die plate (14) to be used in a foil stamping machine (10). The die plate (14) includes a plate steel back (20) to which there is secured an image layer (21). The image layer (21) is secured to the plate steel back (20) by means of a compressible adhesive (22). Preferably, the adhesive (22) is an acrylic polymer. The image layer (21) is formed of metal such as brass, steel, copper, zinc, aluminium, magnesium, or photo-polymer.

### TECHNICAL FIELD

The present invention relates to the field of graphic arts and more particularly to die plates employed in stamping machines such as foil stamping machines.

### BACKGROUND OF THE INVENTION

Described in International Patent Publication No. WO 00/67953 and U.S. Pat. No. 5,904,096 are methods and apparatus relating to foil stamping.

The above-discussed publications disclose a magnetic holding device to secure a steel-backed polymer die plate to a foil stamping heating element.

Conventionally, the die plates are rigid, except for silicon rubber dies. Typically, the image layer is provided by magnesium, brass, copper, steel, zinc or a photo-polymer. However, there is required within the process some compressibility to ensure a quality image is applied to the substrate. Conventionally, the compression takes place in the packing, that is, the material behind the substrate.

It is also the practice in foil stamping to correct low points in the die plate by inserting material behind the packing. Typically, this material is paper or plastics and is fastened in position by means of glue or tape. When the die plate is to be replaced or re-positioned the clean-up will generally require the use of a flammable solvent. Accordingly, the conventional mounting of die plates is time-consuming and requires the undesirable use of flammable solvents.

### OBJECT OF THE INVENTION

It is the object of the present invention to overcome or substantially ameliorate the above disadvantage.

### SUMMARY OF THE INVENTION

There is disclosed herein a die plate for a stamping machine, the die plate including:
a plate steel back to be secured to the machine;
a metal impression layer secured to the steel back and to engage a substrate to impart an image thereto upon pressure being applied to the die plate and substrate by the machine; and
a compressible adhesive securing the image layer to the steel back.

Preferably, the compressible adhesive is an acrylic polymer.

Preferably, the impression layer is formed of brass, steel, copper, zinc, magnesium, aluminium or photo-polymer.

Preferably, said die plate has iron embedded in the adhesive.

Preferably, the adhesive is an epoxy resin.

In one preferred form, the iron embedded in said adhesive is in a particle form.

In a further preferred form, the iron embedded in said adhesive is in the form of a mesh.

In a further preferred form, the iron embedded in said adhesive is in the form of a perforated plate. Preferably, the plate is 0.25 mm to 1 mm in thickness. Preferably, the thickness is about 0.25 mm or 0.6 mm.

### BRIEF DESCRIPTION OF THE DRAWINGS

A preferred form of the present invention will now be described by way of example with reference to the accompanying drawings wherein:

FIG. 1 is a schematic side elevation of a foil stamping machine within which there is located a die plate to apply an image to a substrate;

FIG. 2 is a schematic sectioned side elevation of the die plate employed in the machine of FIG. 1;

FIG. 3 is a schematic side elevation of the foil stamping machine of FIG. 1 with a modified die plate; and

FIG. 4 is a schematic side elevation of the foil stamping machine of FIG. 1 with a further modified die plate.

### DETAILED DESCRIPTION OF THE PREFERRED EMBODIMENTS

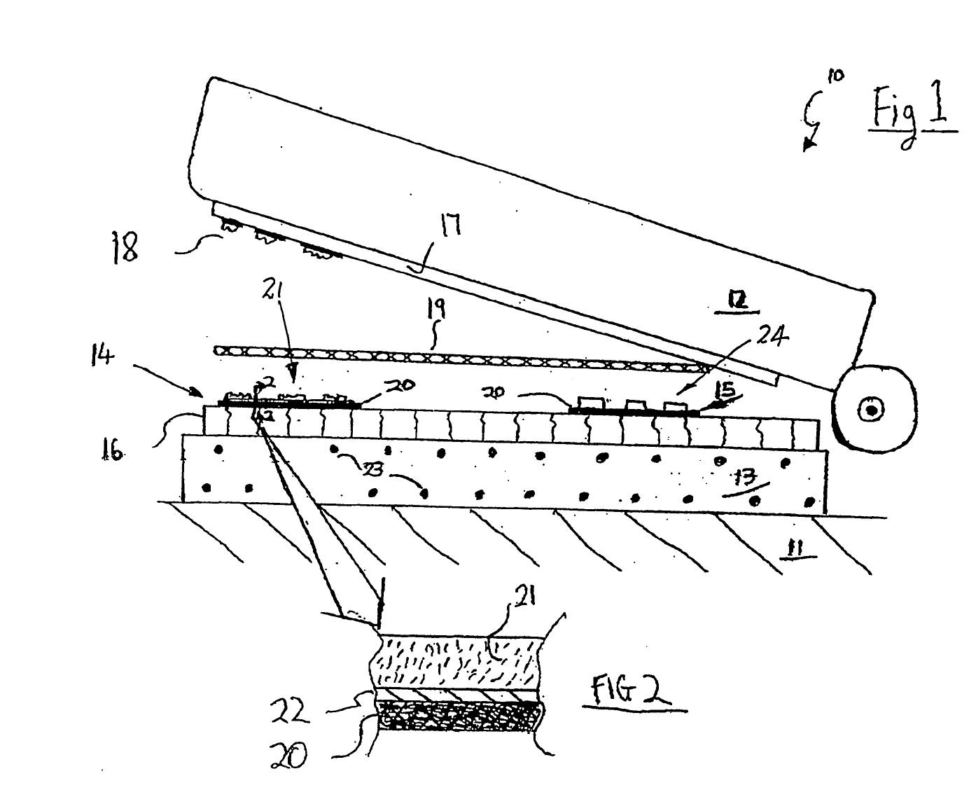

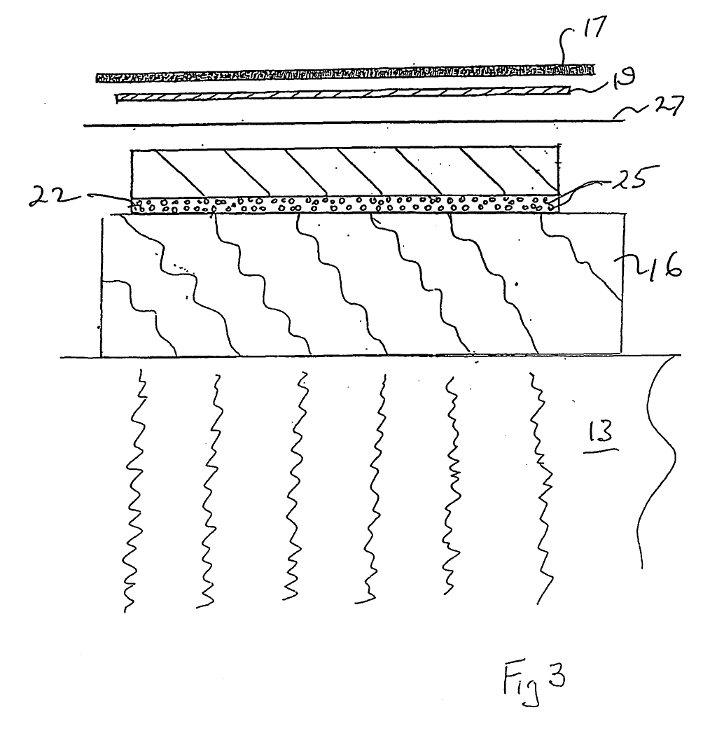

In FIGS. 1 and 2 of the accompanying drawings there is schematically depicted a foil stamping machine 10. The machine 10 includes a base 11 upon which there is pivotally mounted a platen 12. Secured to the base 11 is a bed 13 which is electrically heated by means of heating elements 23. Secured to the bed 13 is a magnetic holding device 16. Typically, the device 16 would be the magnetic holding device described in either of the above-mentioned patent publications.

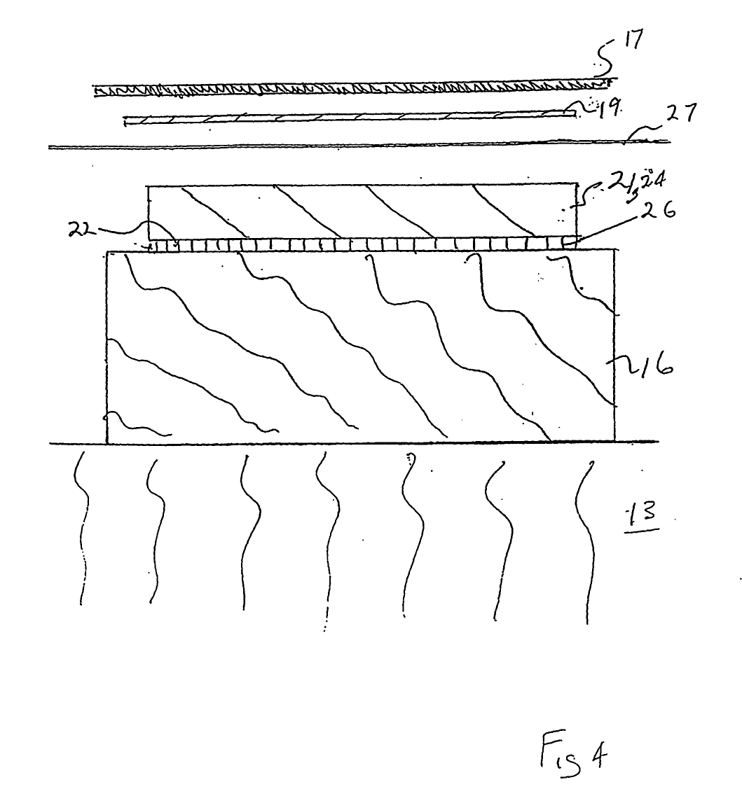

Secured to the device 16 by magnetic attraction are die plates 14 and 15. To cooperate with the die plates 14 and 15 is a jacket member (packing) 17, which is secured to the platen 12, having image portions 18. Preferably, the member 17 is a non-magnetic stainless steel or other non-magnetic metal. The image portions 18 are typically formed of fibreglass. If a foil image is to be applied to a substrate 19, a foil layer (27, FIGS. 3 and 4) is located between the substrate 19 and the die plate 14. The platen 12 applies pressure to the substrate 19 and the foil layer, so that the image is applied to the substrate 19. In addition, the bed 13 heats the die plate 14 to aid in transfer of the foil to the substrate 19.

Each of the die plates 14 and 15 includes a plate steel back 20 to which there are secured image layers 21 and 24 respectively. The layer 21 is secured to the back 20 by means of a compressible adhesive 22. Preferably, the adhesive 22 is an acrylic polymer. The image layer 21 is formed of metal, such as brass, steel, copper, zinc, aluminium, photo-polymer or magnesium, while the layer 24 is formed of a photo-polymer. The above-described preferred embodiments provide the advantage of eliminating the use of having to insert material to “make up” low spots. Accordingly, the above-described preferred embodiment is time-efficient and eliminates the use of flammable solvents.

The above-described preferred embodiment also offers the advantage of substantially ameliorating the crushing and distortion of the substrate, which is of particular interest in security and anti-counterfeiting applications. Preferably, in the case of the die plate 14, the plate steel back 20 would have a thickness of about 0.25 mm and the image layer of a thickness of about 1.50 mm. In respect of the die plate 15, preferably the plate steel back 20 would have a thickness of about 0.6 mm and the image layer (photo-polymer) a thickness of about 1.15 mm.

Accordingly, the die plates 14 and 15 would each have a total thickness of about 1.75 mm.

The above-described preferred embodiment lends itself to the processes of flat-foil stamping, embossing, de-bossing, die-cutting, perforating, top-slitting and a combination of foil stamp embossing and de-bossing.

In FIGS. 3 and 4 of the accompanying drawings, a modified die plate 14 is being used with the machine 10. More particularly, the adhesive layer 22 has embedded in it iron in various forms. The iron has been provided to aid in maintaining the die plates 14 and 15 generally planar. That is, to inhibit distortion due to different heat expansion rates.

In the embodiment of FIG. 3, the iron is in the form of iron particles 25. More preferably, the adhesive 22 within which the iron particles 25 are embedded has a thickness of about 0.25 mm to 1 mm, preferably about 0.25 mm or about 0.6 mm.

In the embodiment of FIG. 4, the adhesive 22 has embedded in it iron in sheet form. For example the sheet form could be woven or non woven mesh or alternatively, perforated iron plate 26. In respect of the plate 26, it would have a thickness of 0.25 mm to 1 mm (preferably about 0.25 mm or about 0.6 mm), with the adhesive 22 extending through the perforations in the plate 26.

In the embodiment of FIGS. 3 and 4 preferably, the adhesive 22 is an epoxy resin. In that respect, it should be appreciated that the epoxy resin is slightly less compressible than the acrylic polymer used with the embodiment of FIGS. 1 and 2. An alternative adhesive is a phenolic based resin.

1. A die plate for a stamping machine, the die plate including:
a plate steel back to be secured to the machine;
a metal impression layer secured to the steel back and to engage a substrate to impart an image thereto upon pressure being applied to the die plate and substrate by the machine; and
a compressible adhesive securing the image layer to the steel back.

2. The die plate of claim 1 wherein the compressible adhesive is an acrylic polymer.

3. The die plate of claim 1 wherein the adhesive is an epoxy resin.

4. The die plate of claim 1 wherein its compressible adhesive is a phenolic based resin.

5. The die plate of claim 1 wherein the impression layer is formed of brass, steel, copper, zinc, magnesium, aluminium or photo-polymer.

6. The die plate of claim 1 wherein said die plate has iron embedded in the adhesive.

7. The die plate of claim 6 wherein the iron embedded in said adhesive is in a particle form.

8. The die plate of claim 6 wherein the iron embedded in said adhesive is in the form of a mesh.

9. The die plate of claim 6 wherein the iron embedded in said adhesive is in the form of a perforated plate.

10. The die plate of claim 1 wherein the plate has thickness of about 0.25 mm to about 1 mm.

11. The die plate of claim 10 wherein the die plate has a thickness of about 0.25 mm.

12. The die plate of claim 10 wherein the die plate has a thickness of about 0.6 mm.
